(19) United States
(12) Patent Application Publication
(10) Pub. No.: US 2015/0169533 A1
(43) Pub. Date: Jun. 18, 2015

(54) Server-less HTML Templates

(71) Applicants: Constantinos MICHAEL, New York, NY (US); Steffen MESCHKAT, Zurich (CH); Tobias BOONSTOPPEL, New York, NY (US); Stefan HAUSTEIN, Zurich (CH)

(72) Inventors: Constantinos MICHAEL, New York, NY (US); Steffen MESCHKAT, Zurich (CH); Tobias BOONSTOPPEL, New York, NY (US); Stefan HAUSTEIN, Zurich (CH)

(73) Assignee: Google Inc., Mountain View, CA (US)

(21) Appl. No.: 13/253,814

(22) Filed: Oct. 5, 2011

Related U.S. Application Data
(60) Provisional application No. 61/431,735, filed on Jan. 11, 2011.
(60) Provisional application No. 61/457,350, filed on Mar. 4, 2011.

(51) Int. Cl. G06F 17/24; G06F 17/21

(52) U.S. Cl. CPC G06F 17/248; G06F 17/212

(57) ABSTRACT

A method, system and computer-readable medium for generating an HTML document in a server-less environment.

### BACKGROUND

The emergence and development of computer networks and protocols, such as the Internet and the World Wide Web (or simply “web” or “Web”), allow users to download and display dynamic webpages on their own computers. One way to display large quantities of data on a webpage is to include data into templates. Templates maintain the layout and design of a webpage while the webpage updates its content.

Conventional template processing systems, combine templates and content on a web server in response to a request for a webpage. The web server then sends the webpage to a requesting computing device. Conventional template processing systems cannot create and render a webpage on a computing device that does not include a web server and does not have a connection to the Web.

### BRIEF SUMMARY

Methods, systems, and computer program products are disclosed to display an HTML document in a server-less environment.

According to an embodiment, a method for displaying an HTML document in a server less environment, is provided.

According to another embodiment, a system for displaying an HTML document in a server less environment, is provided.

According to yet another embodiment, an article of manufacture including a computer-readable medium having instructions stored thereon that cause the computing device to perform operations for generating an HTML document in a server less environment, is provided.

Further features and advantages of the present invention, as well as the structure and operation of various embodiments thereof are described in detail below with reference to the accompanying drawings. It is noted that the invention is not limited to the specific embodiments described herein. Such embodiments are presented herein for illustrative, purposes only. Additional embodiments will be apparent to persons skilled in the relevant art(s) based on the teachings contained herein.

### BRIEF DESCRIPTION OF THE DRAWINGS/FIGURES

References will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a block diagram of an exemplary system of an environment capable of generating HTML document in a server-less environment.

FIG. 2 is a block diagram of an exemplary embodiment of generating an HTML document.

FIG. 3 is a flowchart of an exemplary method for generating an HTML document in a server-less environment.

FIG. 4 is a flowchart of an exemplary method for evaluating a custom attribute.

FIG. 5 is a block diagram of an example computer system.

### DETAILED DESCRIPTION OF EMBODIMENTS

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

A server-less template processing system includes multiple advantages over conventional template processing systems. In one example, an application developer can develop and render a webpage without a need for a web server. Moreover, an application developer may update the content of the rendered webpage. In another example, a user can render content on a webpage without having a connection to the World Wide Web.

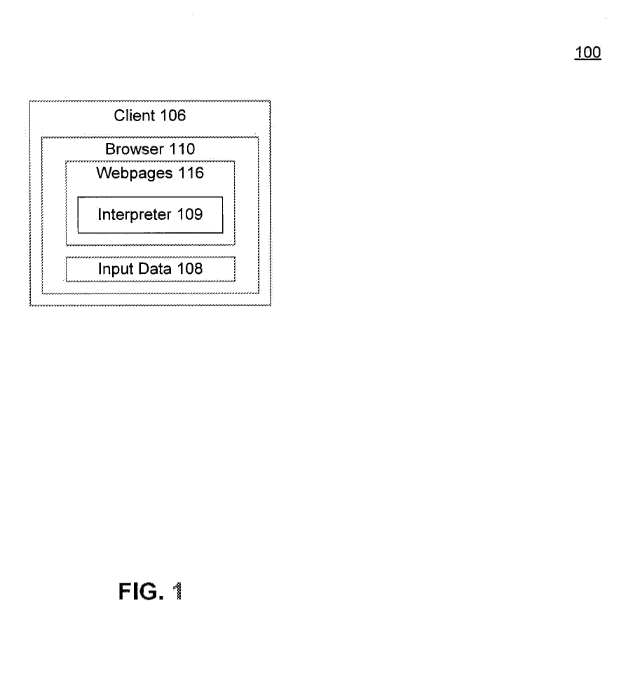

FIG. 1 is a block diagram of an exemplary system 100 of an environment capable of generating an HTML document in a server less environment. System 100 includes a client 106.

Clients 106 are electronic computing devices such as a personal computers, mobile communication devices, (e.g. smart phones, tablet computing devices, notebooks), set-top boxes, game-consoles, embedded systems, and other devices. A client as described herein, does not necessarily need to communicate with a web server. Client 106 includes a browser 110, webpages 116 and an interpreter 109. Client 106 also includes a storage area for input data 108. In an embodiment, input data 108 is content that browser 110 displays on webpages 116.

Browser 110 is an application that executes on client 106. Browser 110 displays HTML documents as webpages 116 to a user. In an embodiment, browser 110 can be a browser such as the CHROME browser from Google, Inc.

Webpage 116 is a document, such as an HTML document or a resource containing information that, in an embodiment, can be displayed over the World Wide Web and/or can be accessed using browser 110. Webpage 116 may be displayed on a display screen associated with client 106.

Unlike conventional template processing systems, such as Cold Fusion, Django and PHP, the template processing system described herein, in accordance with the embodiments, creates an HTML document on client 106, and does not require a web server to create an HTML document. Instead, interpreter 109 generates an HTML document that includes input data 108 without the need of a server. Once generated, browser 110 displays the HTML document on a display screen. For example, interpreter 109 may generate a HTML document that shows a webpage 116 of a view the of Earth on Google Maps, without using a web server 104.

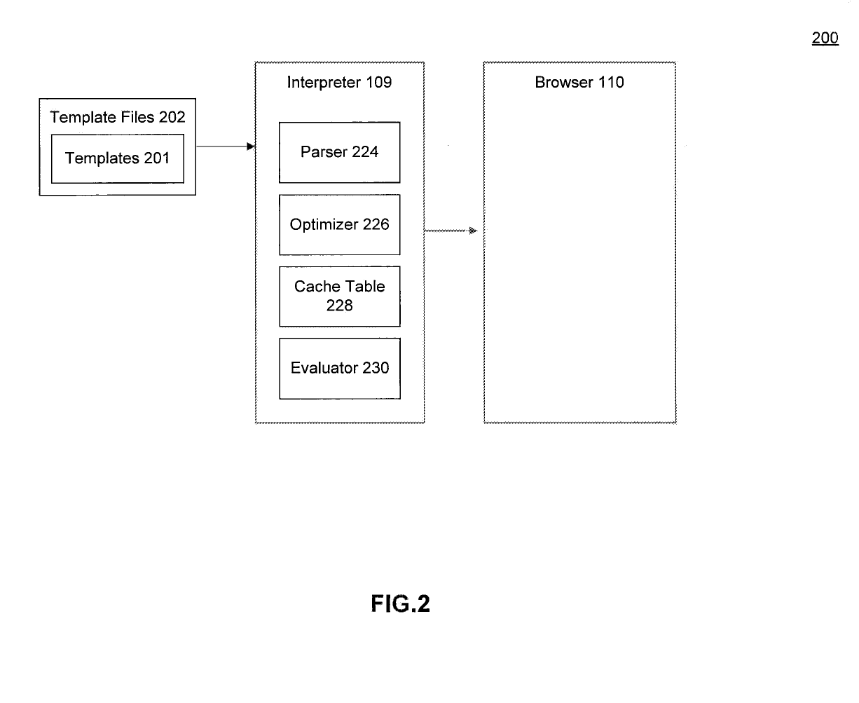

FIG. 2 is an exemplary embodiment 200 of an interpreter. Interpreter 109 generates an HTML document from templates 201 included in template files 202. In an embodiment, interpreter 109 also processes custom attributes included in templates 201, such example custom attributes described herein. In an embodiment, interpreter 109 may also update input data 108 on browser 110 once the HTML document is displayed as a webpage with minimal reprocessing computations.

In another embodiment, browser 110 includes interpreter 109 when browser 110 is installed on client 106. In another embodiment, interpreter 109 may be built into browser 110 or may be a plug-in library downloaded on browser 110.

Interpreter includes a parser 224, an optimizer 226, a cache table 228 and an evaluator 230. In an embodiment, interpreter 109 evaluates custom attributes that are included in template files 202 that include templates 201.

Template 201 includes formatted code, such as HTML markup code, processing instructions, expressions and custom attributes that are interpreted by interpreter 109. Template 201 may be statically modified by being loaded into an HTML editor or browser 110 prior to the building and compilation process.

In an embodiment, template 201 includes custom attributes. Each custom attribute includes template processing directives. In a non-limiting example, custom attributes may include, as explained in further detail below, jsimport, jstemplate, jscontent, jsselect, jsvar and jsif, to name only a few. Exemplary template processing directives include static expressions that may be a subset of JavaScript. When interpreter 109 receives the custom attributes interpreter 109 uses processing directives included in the custom attributes to evaluate input data 108 and determine the placement of input data 108 in the HTML document.

Another example of a custom attribute is jstemplate. Jstemplate is a custom attribute that identifies template 201 to interpreter 109. For example,

<div jstemplate=“line_snippet_template;
snippet:maps_jslayout.LineSnippet”>

In the example above, template “snippet” expects input data 108 from protocol buffer message “LineSnippet” included in namespace maps_jslayout.

Another example of a custom attribute is jscontent. During execution, custom attribute jscontent indicates to interpreter 109 to substitute the content of HTML element in template 201 with a value of input data 108 specified in protocol buffer message 218. For example,

<span jscontent=“snippettext”></span>

In the example above, the text that is inserted between HTML tag <span> and </span> is the value of field “text”, in the input parameter “snippet”.

Another example of a custom attribute is jsvalues. Jsvalues sets an HTML attribute to a value of the field in the input parameter. For example,

<div jsvalues=“id:snippet.type+snippet.id”>

In the example above, tag <div> includes text that has values from the field “type” and the value from the field “id” included in the input parameter “snippet.”

In another example, a combination of custom attributes jsif and jscontent may specify conditions when specific template sections may be omitted or hidden in the valid HTML document. For example:

```
<div jsif=“has(‘snippet.id’)”
    jscontent=“snippet.text”
    jsvalues=“id:snippet.type + snippet.id”>
  This text is replaced with snippet text.
</div>
```

In the example above, an HTML document displays the value of the fields “text” “type” and “id” from the input parameter “snippet” if the field “id” is set to a value.

Another example of a custom attribute is jsselect. Jsselect is an example of a for loop inside template 201. For example, jsselect iterates over an array in a protocol buffer “Result” and produces lines of input data 108, different input data 108 included on each line. For example,

```
<div jstemplate=″result_template;
result_message:maps_jslayout.Result″>
Snippets:
<div jsselect=”snippet, i, total:
              result_message.line_snippet_array”>
<span jscontent=“‘snippet’+ (1 + i) + ‘ of ’ + total”>
        Text here is replaced with “snippet X of Y”
</span>
<div use=″line_snippet_template_file.html#line_snippet_template”>
        Text here is replaced with contents of transclusion.
</div>
</div>
</div>
```

Custom attribute jsselect iterates over the field “line_snippet_array” in the input parameter “result_{—} message.” The value of the field “result_ message” is written into the input parameter “snippet.” Jsselect uses “i” as a counter to keep track of the number of iterations performed on the input parameter “result_message.” In the example above, for each snippet in “result_message” interpreter 209 generates a line “‘snippet’+(1+i)+‘of’+total” where ‘i’ indicates the number of snippets in the HTML document.

In another embodiment, a developer uses custom attributes in template 201 to compose output from multiple templates (also known as “transclusion”). Transclusion occurs when a content of an element, such as an HTML element in one template, replaces a content from an element from another template.

For example, in template file 202, such as “result_template_file.html” below, a developer defines a transcluding template.

```
<html jsimport=“template/prototemplate/jslayout/examples/snippet/
result.proto”>
  <div jstemplate=“result_template;
  result_message:maps_jslayout.Result”>
  Snippets:
  <div jsvars=“total:size(‘result_message.line_snippet_array’)”
    jsselect=“snippet, i: result_message.line_snippet_array”>
    <span jscontent=“‘snippet’+ (1 + i) + ‘ of ’ + total”>
    Text here is replaced with “snippet X of Y”
    </span>
    <div use=“line_snippet_file.html#line_snippet_template”>
    Text here is replaced with transcluded and processed template.
    </div>
  </div>
  </div>
</html>
```

Template “result_template” in template file “result_template_file.html” is a transcluding template. A transcluding template is template 201 that includes a transcluded template. A transcluded template is template 201 that can render a valid HTML output stream, but that may also be included in a transcluding template. A transcluded template may be included in the same or different template file 202 as a transcluding template.

In an embodiment, custom attribute “use” in the transcluding template includes credentials that identify the transcluded template file and the transcluded template. In an embodiment, an application developer sets custom attribute “use” to a uniform resource locator (URL) that includes a path to the transcluded file, such as “line_snippet_file.html” described below.

```
<html jsimport=“template/prototemplate/jslayout/examples/snippet/
result.proto”>
  <div jstemplate=“line_snippet_template;
            snippet:maps_jslayout.LineSnippet”>
  <div jsif=“has(‘snippet.id’)”
    jscontent=“snippet.text”
    jsvalues=“id:snippet.type + snippet.id”>
    This text is replaced with snippet text.
  </div>
  </div>
<html>
```

The URL further contains an identifier, such as “#”, followed by the name of the transcluded template. For example, “#line_snippet_template” identifies a transcluded template “line_snippet_template,” in template file “line_snippet_file.html”,

In an embodiment, during transclusion, interpreter 109 identifies the rendering credentials that are associated with the transcluded template, and inserts the rendering credentials into the transcluding file. For example, CSS rules that are associated with the transcluded template may be inserted into the transcluding template with the identifier that corresponds to the transcluded template. As a result, when the transcluded template is being rendered in the transcluding file, the transcluded template is governed by the associated CSS rules.

A person skilled in the art will appreciate that custom attributes and their corresponding utilization described herein are given by way of example and not limitation, and that there are other ways custom attributes may be utilized to expand dynamic functionality in template 201.

In an embodiment, a user may use a file managing application, such as WINDOWS EXPLORER or APPLE FINDER to activate interpreter 109 to display an HTML document, by, for example, opening template file 202. In an embodiment, when user opens template file 202, browser 110 begins to load the contents of template file 202. In an embodiment, browser 110 activates interpreter 109 when browser 110 executes an “onLoad( )” function included in the closed HTML script tag, such as </body> (the script tag may also be referred to as body.onload.) A person skilled in the art will appreciate that when browser 110 loads template file 202, browser 110 creates a Document Object Model (DOM) structure from template file 202 using, for example, its own parser or a DOM manipulator.

In an embodiment, browser 110 activates interpreter 109 by making a call to the Java Script library the hosts interpreter 109. When activated, interpreter 109 begins to traverse the DOM structure. As interpreter traverses from node to node in the DOM structure interpreter 109 may encounter a node that includes a custom attribute.

When activated interpreter 109 encounters each node that includes a custom attribute, interpreter 109 processes the custom attribute. Parser 224 component in interpreter 109 performs a syntactic analysis of the custom attribute and nodes in the DOM structure that are associated with the custom attribute. For example, parser 224 verifies that the syntax of each custom attribute and processing instructions associated with the custom attribute are compatible with the format described herein.

In an embodiment, after parser 224 completes verification, optimizer 226 determines whether any instructions included in custom attribute can be optimized. Optimizer 226 optimizes processing instructions so that they are efficient in terms of speed and system resources, such as memory and control processing unit (CPU) time when processing instructions and expressions are being evaluated.

In an embodiment, after optimizer 226 completes optimizing processing instructions in custom attribute, interpreter 109 stores the custom attribute and the processing instructions in cache table 228. In an embodiment, processing instructions and custom attributes are stored in cache table 228 for an efficient retrieval and processing if a user decides to update input data 108. For example, results of the processing instructions, text expressions, etc. associated with a custom attribute, may be stored in the cache table 228.

For example, in the code below:

<div jsselect=“snippet, i, total: result_message.line_snippet_array”>

if the input data 108 included in the line_snippet_array generates a set of four rows when interpreter 109 evaluates the processing instructions the first time, cache table 228 may store the “total” parameter, which includes the number of rows. Because the number of rows are stored, if interpreter 109 receives input data 108 that generates more rows, interpreter accesses the “total” parameter stored in the table cache, and adds the extra number of rows. Similarly, when input data 108 generates fewer number of rows, evaluator 230 subtracts the access number of rows from the “total” parameter stored in cache table 228.

In an embodiment, evaluator 230 evaluates custom attributes that are associated with processing instructions. As part of an evaluation process interpreter 109 retrieves input data 108 that is stored on client 106. Evaluator 230 combines the processing instructions with input data 108 and renders a text output string.

In an embodiment, interpreter 109 stores the text output string in the DOM structure in place of the node that included a custom attribute.

When interpreter 109 completes the evaluation of the custom attributes included in DOM structure, browser 110 creates an HTML document from the DOM structure. In an embodiment, browser's 110 DOM manipulator traverses the DOM structure and creates an HTML document.

In an embodiment, browser 110 displays an HTML document as webpage 116 using a local access URL, such as file://URL.

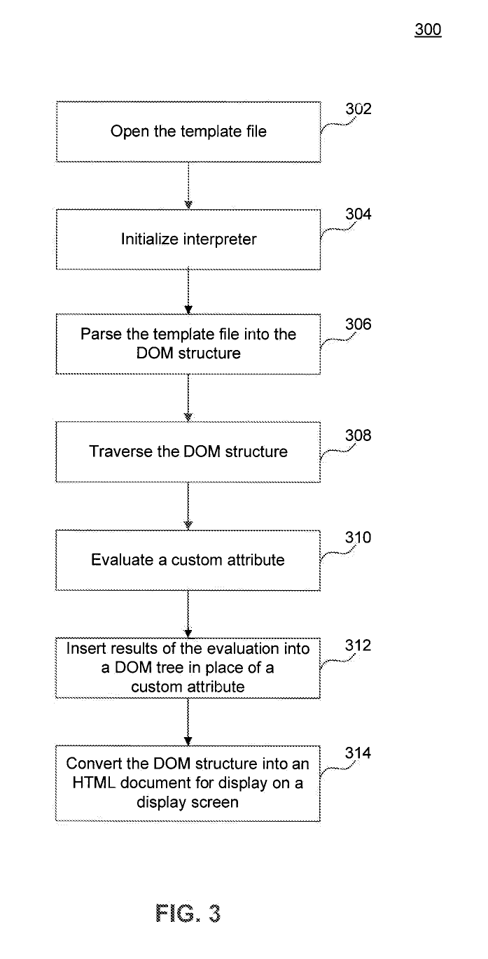

FIG. 3 is a flowchart of a method 300 of an interpreter generating an HTML document, according to an embodiment.

At stage 302, a template file is opened. For example, a user may open a template file 202 from a file manager. When template file 202 is opened, browser 110 begins to load template file 202.

At stage 304, interpreter is initialized. For example, browser 110 initializes interpreter 209 when it executes the onLoad( ) function in the HTML body tag.

At stage 306, the template file is parsed and a DOM structure is created. For example, browser 110 creates a DOM structure from contents included in template file 202. The DOM structure includes HTML tags, expressions, custom attributes and processing instructions.

At stage 308, a DOM structure traversal occurs. For example, interpreter 109 traverses the DOM structure. When interpreter encounters a custom attribute, the flowchart proceeds to stage 310. Otherwise, the flowchart remains at stage 308.

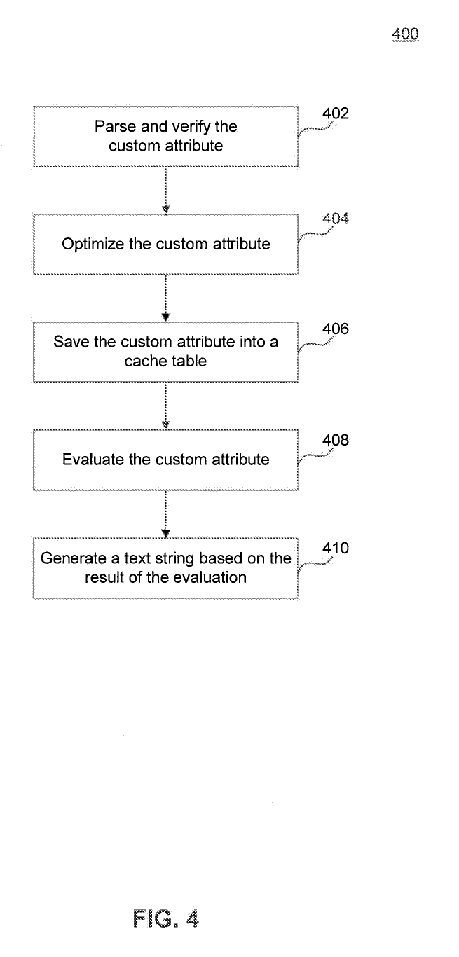

At stage 310, a custom attribute is evaluated. FIG. 4, is a flowchart of a method 400 of evaluation of a custom attribute, according to an embodiment.

At stage 312, the results of the evaluation are inserted into the DOM structure. For example, interpreter 109 inserts the results of the evaluation into the DOM structure in place of a custom attribute.

At stage 314, the DOM structure is converted into an HTML document and is displayed to the user. For example, browser 110 uses a DOM manipulator to convert the DOM structure into an HTML document so it can be display on a screen.

FIG. 4 is a flowchart of a method 400 for evaluating a custom attribute, according to an embodiment.

At stage 402, a custom attribute is parsed. For example, parser 224 performs a syntactic analysis of the custom attribute and nodes in the DOM structure that are associated with the custom attribute, such as, processing instructions. In an embodiment, the custom attribute may also be verified.

At stage 404, instructions in the custom attribute are optimized. For example, optimizer 226 optimizes the instructions in the custom attribute.

At stage 406, custom attribute is stored in the cache table. For example, custom attribute and the instructions associated with the custom attribute may be stored in cache table 228.

At stage 408, processing instructions and expressions in the custom attribute are evaluated. For example, evaluator 230 evaluates the processing instructions and expressions in custom attributes. As part of the evaluation process, interpreter 109 retrieves input data 108 from storage and inserts input data 109 into processing instructions for evaluation and rendering.

At stage 410, a text string based on the evaluation is generated. For example, evaluator 228 generates a text string based on the results of the evaluation and input data 108. After stage 412, the flowchart proceeds to stage 312.

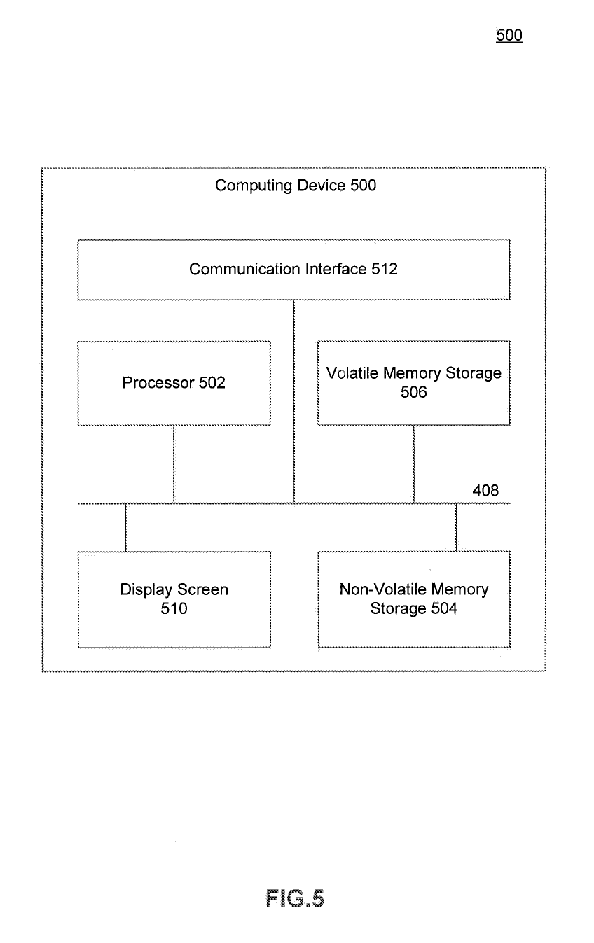

FIG. 5 is an example computer system 500 in which embodiments of the present invention, or portions thereof, may by implemented as computer-readable code. For example, the components or modules of system 100 may be implemented in one or more computer systems 500 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-4.

Client 106 can include one or more computing devices. According to an embodiment, client 106 can include one or more processors 502, one or more non-volatile storage mediums 504, one or more memory devices 506, a communication infrastructure 508, a display screen 510 and a communication interface 512. Processors 502 can include any conventional or special purpose processor, including, but not limited to, digital signal processor (DSP), field programmable gate array (FPGA), and application specific integrated circuit (ASIC). Non-volatile storage 504 can include one or more of a hard disk drive, flash memory, and like devices that can store computer program instructions and data on computer-readable media. One or more of non-volatile storage device 504 can be a removable storage device. Memory devices 506 can include one or more volatile memory devices such as, but not limited to, random access memory. Communication infrastructure 508 can include one or more device interconnection buses such as Ethernet, Peripheral Component Interconnect (PCI), and the like.

Typically, computer instructions executing on client 106 are executed using one or more processors 502 and can be stored in non-volatile storage medium 504 or memory devices 506.

Display screen 510 allows results of the computer operations to be displayed to a user or an application developer.

Communication interface 512 allows software and data to be transferred between computer system 500 and external devices. Communication interface 512 may include a modem, a network interface (such as an Ethernet card), a communications port, a PCMCIA slot and card, or the like. Software and data transferred via communication interface 512 may be in the form of signals, which may be electronic, electromagnetic, optical, or other signals capable of being received by communication interface 512. These signals may be provided to communication interface 512 via a communications path. Communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary section may set forth one or more but not all exemplary embodiments as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A computer-implemented method for displaying an HTML document in a server-less environment, comprising:
accessing templates included in template files stored in a disk directory of a client, the templates including custom attributes associated with the templates, wherein the custom attributes indicate template processing instructions specific to each of the custom attributes that generate the HTML document and process input data;
generating a DOM structure having a plurality of nodes, the DOM structure including content in the template files;
for each node in the plurality of nodes:
identifying the node in the plurality of nodes that includes a custom attribute associated with a template from one of the template files;
evaluating the custom attribute using the template processing instructions specific to the custom attribute, including retrieving the input data from a location in the server-less environment separate from the template file, and generating a custom attribute result using the retrieved input data and the template processing instructions;
generating an expression, the expression containing the custom attribute result; and
inserting the expression into the DOM structure in place of the custom attribute; and
rendering the HTML document from the expressions in the plurality of nodes in the DOM structure on a display screen of the client.

2. (canceled)

3. The computer-implemented method of claim 1, further comprising:
displaying the HTML document using a local access URL.

4. The computer-implemented method of claim 1, wherein evaluating farther comprises:
parsing a custom attribute and associated template processing instructions.

5. The computer-implemented method of claim 1, wherein evaluating further comprises:
storing the template processing instructions associated with a custom attribute in a cache table.

6. (canceled)

7. The computer-implemented method of claim 1, wherein the evaluation includes a transclusion.

8. The computer-implemented method of claim 1, further comprising:
initializing an interpreter to perform the evaluation, wherein initializing includes executing a method within the template file.

9. The computer-implemented method of claim 8, wherein the method is an onLoad function within the HTML document included in the template file.

10. A system for displaying an HTML document in a server-less environment, comprising:
a processor;
a memory coupled to a processor; and
a browser executing on the processor and stored in memory and configured to:
access templates included in template files stored in a disk directory of a client, the templates including custom attributes associated with the templates, wherein the custom attributes indicate template processing instructions specific to the custom attributes that generate the HTML document and process input data;
generate a DOM structure having a plurality of nodes, the DOM structure including a content in the template files;
for each node in the plurality of nodes, an interpreter configured to:
identify the node in the plurality of nodes that includes a custom attribute associated with a template from one of the template files;
evaluate the custom attribute using the template processing instructions specific to the custom attribute, wherein to evaluate the interpreter is further configured to:
retrieve the input data from a location in the server-less environment separate from the template file; and
generate a custom attribute result using the retrieved input data and the template processing instructions;
generate an expression, the expression containing the custom attribute result; and
insert the expression into the DOM structure in place of the custom attribute; and
render the HTML document from the expressions in the plurality of nodes in the DOM structure on a display screen of the client.

11. (canceled)

12. The system claim 10, wherein the interpreter includes a local access URL for display of the HTML document.

13. The system claim 10, wherein the interpreter is further configured to parse a custom attribute associated with the template processing instructions.

14. The system claim 10, wherein the interpreter is further configured to store the template processing instructions associated with a custom attribute in a cache table.

15. (canceled)

16. The system claim 10, wherein the evaluation includes a transclusion.

17. The system of claim 10, wherein the browser is further configured to initialize an interpreter by executing a method included within the template file.

18. The system of claim 17, wherein the method is an onLoad function within the HTML document included in the template file.

19. A computer usable storage medium having a plurality of instructions stored thereon that, when executed by one or more processors, cause the one or more processors to display an HTML document in a server-less environment, comprising:
accessing templates included in template files stored in a disk directory of a client, the templates including custom attributes associated with the template, wherein the custom attribute indicates template processing instructions specific to the custom attributes that generate the HTML document and processing input data;
generating a DOM structure having a plurality of nodes, the DOM structure including content in the template files;
for each node in the plurality of nodes:
identifying the node in the plurality of nodes that includes a custom attribute associated with a template from one of the template files;
evaluating the custom attribute using the template processing instructions specific to the custom attribute, including retrieving the input data from a location in the server-less environment separate from the template file, and generating a custom attribute result using the retrieved input data and the template processing instructions; and
generating an expression, the expression containing the custom attribute result; and
inserting the expression into the DOM structure in place of the custom attribute; and
rendering the HTML document from the expressions in the plurality of nodes in the DOM structure on a display screen of the client.

20. The computer readable storage medium of claim 19, wherein the instructions farther comprise operations, the operations comprising:
storing the template processing instructions associated with a custom attribute in a cache table.

21. The method of claim 1, wherein retrieving the input data further comprises retrieving a protocol buffer message specified in a template; and
storing the input data in the protocol buffer message prior to generating the custom attribute result.

22. The system of claim 10, wherein the interpreter is further configured to:
retrieve the input data using a protocol buffer message specified in the template; and
store the input data in the protocol buffer message prior to generating the custom attribute result.

23. The computer readable storage medium of claim 19, wherein the instructions comprising operations for retrieving the input data further comprise operations, the operations comprising:
retrieving the input data using a protocol buffer message specified in a template; and
storing the input data in the protocol buffer message prior to generating the custom attribute result.
